(19) United States
(12) Patent Application Publication
(10) Pub. No.: US 2003/0053092 A1
(43) Pub. Date: Mar. 20, 2003

(54) Film chart original plate and film chart

(75) Inventor: Akito Ohkubo, Kanagawa (JP)

Correspondence Address: SUGHRUE, MION, ZINN,, MACPEAK & SEAS, PLLC, 2100 Pennsylvania Avenue, N.W., Washington, DC, 20037-3202, US

(73) Assignee: FUJI PHOTO FILM CO. LTD.

(21) Appl. No.: 10/229,127

(22) Filed: Aug. 28, 2002

(30) Foreign Application Priority Data
Aug. 29, 2001 (JP) 2001-258971

(51) Int. Cl. B41J 1/00; G06F 15/00

(52) U.S. Cl. 358/1.9

(57) ABSTRACT

A film chart original plate 300 is provided with a black patch 311 and a series of gray patches 312. The series of gray patches 312 have a series of optical densities including optical densities smaller 3.5 or more than the optical density of the black patch 311.

### BACKGROUND OF THE INVENTION

1. Field of the Invention

The present invention relates to a film chart original plate for creating a film chart in which a plurality of patches is arranged, and the film chart.

2. Description of the Related Art

There is known various types of input devices for obtaining image data through input of an image, for example, a color scanner for reading a recorded image to obtain image data and a digital still camera (DSC) in which image data is obtained in such a manner that an image of a subject is formed on a solid state imaging device and then read. In those input devices, the image data is represented by data of a predetermined range of for example 0 to 255 on each of three colors for example red (R), green (G) and blue (B). Colors, which can be represented by numerical values within the predetermined range on each of those three colors of R, G and B, are restricted as a matter of course. For this reason, even if colors of the original image have very plentiful representation, conversion of the colors into image data once using such an input device causes an image represented by the image data to be restricted to the colors in a certain color representation area represented by a cube and a rectangular parallelepiped in the R, G and B color space.

Also with respect to an output device for outputting an image in accordance with image data, there are known various types of output devices, for example, a photographic printer in which a printing paper is exposed by a laser beam to develop the printing paper so that an image is recorded on the printing paper, a printer in which an image is recorded on a sheet in accordance with a system such as an electrophotographic system and an inkjet system, a printing machine in which a rotary press is rotated to create a number of printed matters, and an emissive display device such as a CRT display and a plasma display in which light is emitted on a display screen in accordance with image data to display an image. Also with respect to an output device, similar to the above-mentioned input device, there exists a color reproduction area according to the associated output device. That is, the output device is able to represent various colors in accordance with for example image data representative of three colors of R, G and B or image data representative of four colors of C (cyan), M (magenta), Y (yellow) and K (black). However, colors, which can be represented, are restricted to a certain color representation area (for example, a color representation area represented by numerical values of a range of 0 to 255 on each of colors of R, G and B) represented by a cube and a rectangular parallelepiped in an output device color space (for example, an RGB space and a CMYK space).

Even if a certain image data (for example, data representative of (R, G, B)=(50, 100, 200)) is concerned, a color of an image, which is obtained in accordance with such image data, is varied depending on a sort of an output device. Regarding this point, it is the same between an input device and an output device. Even if image data (R, G, B)=(50, 100, 200), which is obtained by a certain input device, is used as it is, and an image is outputted by a certain output device, a color of an image outputted from the output device is not coincident with a color of the original image entered through the input device. Accordingly, when it is intended that the original image is reproduced by a certain output device in accordance with image data obtained through reading an image by a certain input device, there is a need to convert the image data but not directly sending the image data obtained in the input device to the output device. Here, there is performed a conversion paying attention to a color of an image, and a conversion of such image data is referred to as color conversion. A LUT (Lookup table) or the like defining a relationship between image data before and after the color conversion is referred to as a color conversion definition (a color profile). Creating the color conversion definition (a color profile) is referred to as a profiling. The color conversion definition defines the association between coordinate values of two color spaces.

To perform the color conversion between the devices, there is proposed a scheme adopting a color conversion in which a common color space (a space of a device independent data) independent of a device, for example, an L*a*b* color space, is interposed, so that a color conversion for converting image data on a color space depending on an input device, which is obtained by the input device, is converted into image data on the common color space, and a color conversion for converting the image data on the common color space into image data on a color space depending an output device are performed. In the conversions according to this scheme, there are used a color profile defining a color conversion between a color space depending on an input device and a common color space, and a color profile defining a color conversion between a color space depending on an output device and the common color space.

By the way, with respect to an apparatus generally referred to as a photographic printer in which an image formed on a photographic film through photography and development is printed on a photographic paper, and the photographic paper is developed, recently, a so-called digital printer appears.

According to the digital printer, a print photograph is formed in such a manner that an image recorded on a photographic film after development or a color negative film is read on a photoelectric basis using a negative scanner having a CCD photosensor and the like; various sorts of image processing are applied to the image thus obtained through reading (in order to avoid troublesomeness of expression it happens that an image on data is simply referred to as an image too); a laser light is modulated in accordance with an image after the processing; an image is printed on a photographic paper by the modulated laser light; and the photographic paper after the printing is developed.

Further, according to the digital printer, in order to provide a fine print photograph proper in density and tint, the image obtained through reading on a photoelectric basis from the developed photographic film is displayed on a display to examine the density and the tint. Examination results of the density and the tint are reflected on for example image processing conditions in an image processing. Thus, a fine print photograph proper in density and tint can be formed in such a manner that the image processing is performed using the image processing conditions on which the examination results are reflected, and a laser light for printing onto the photographic paper is modulated in accordance with the image after the image processing.

Thus, according to the digital printer, since the examination is performed on the display, there is performed a profiling for reproducing a photographed image. In the profiling, there is a need to provide a color profile associated with a negative scanner. The color profile defines the association between coordinate values of a common color space representative of colors of light for exposure of a photographic film (a color negative film) and data values in which points exposed by the light are read by the CCD photosensor and the like.

As a technique of creating the color profile of the negative scanner, there is considered a technique in which a so-called Macbeth chart is photographed by a camera, and colorimetry for color patches constituting the Macbeth chart and reading of color patches constituting a film chart through photographing the Macbeth chart are performed so that the color profile is created in accordance with the association between calorimetric values and reading data.

However, the color negative film uses a photosensitive material, in which a so-called exposure area is very wide, for the purpose of providing a margin in selection of a stop at the time of photography. Thus, it is necessary for the color profile for the digital printer to be able to associate with such a wide exposure area.

A color profile, which is obtained in accordance with photography of Macbeth chart, simply may cover only a part of the exposure area. Accordingly, it is considered for example that a plurality of number of times of photography is performed while stop of a camera is changed in a plurality of steps so that a number of film charts is created, and the color profile is created in accordance with a number of film charts. However, it takes a great deal of time and labor that such a number of film charts is created, and mutual coupling among the film charts is wrong. Accordingly, it is surmised that the color profile will be low in accuracy.

### SUMMARY OF THE INVENTION

In view of the foregoing, it is an object of the present invention to provide a film chart original plate for creating a film chart capable of readily obtaining a great accuracy of color profile for a negative scanner, and the film chart.

To achieve the above-mentioned object, the present invention provides a film chart original plate for creating a film chart, in which a plurality of patches is arranged, by a contact printing onto a color negative film, said film chart original plate comprising:

a black patch section having a predetermined black patch; and

an achromatic patch section in which a series of achromatic patches associated with a series of optical densities including optical densities smaller 3.5 or more than optical density of said black patch are arranged.

In the film chart original plate according to the present invention as mentioned above, it is preferable that said achromatic patch section is one in which a series of achromatic patches associated with a series of optical densities including optical densities smaller 4.0 or more than optical density of said black patch are arranged.

In the event that the film chart original plate having an achromatic (gray) patch over the optical density difference not less than 3.5 is used, and light quantity of a light source for exposure is appropriately set up to perform a contact printing onto the color negative film, a wide range of exposure area, which includes a portion changing over from the straight line portion of the characteristic curve of the color negative film to the shoulder, and a portion changing over from the straight line portion of the characteristic curve of the color negative film to the leg, is exposed once. And in the event that the film chart original plate having an achromatic (gray) patch over the optical density difference not less than 4.0 is used, a wide range of exposure area, which includes the shoulder to the leg, is exposed once. The use of the film chart thus created, wherein the wide range of exposure area is exposed once, makes it possible to readily obtain a great accuracy of color profile.

In the film chart original plate according to the present invention as mentioned above, it is preferable that said achromatic patch section is one in which of the series of achromatic patches, a lowest density of patch is a punched patch.

In the film chart original plate according to the present invention as mentioned above, it is also preferable that said black patch section is one in which as the black patch, a patch made of an optical shield material is provided.

A punch provided on the achromatic patch portion and a patch made of light shielding material provided on the black patch portion are utilized as patches corresponding to both edges of the optical density realizable as the original plate, and contribute to spreading width of light exposure realized by once printing.

In the film chart original plate according to the present invention as mentioned above, it is preferable that said achromatic patch section is one in which a monochrome film is exposed and developed.

Also it is preferable that said achromatic patch section is one in which a monochrome film for photogravure is exposed and developed.

The monochrome film is excellent in gray balance and is wide in density realizable, and thus it is suitable as a material for the film chart original plate. Particularly, the monochrome film for photogravure is easy to create a halftone of gray and thus suitable as a material for the film chart original plate.

In the film chart original plate according to the present invention as mentioned above, it is preferable that the film chart original plate further comprises a color patch section in which a plurality of color patches each having a predetermined color, and a predetermined reference patch are arranged, wherein said achromatic patch section is one in which a reference patch having a same spectral transmission factor as the reference patch of said color patch section is arranged.

In the event that the film chart original plate according to the present invention is used to create a film chart, it is preferable to vary the exposure by the achromatic patch section and the color patch section to meet characteristics of the negative film as the material. In the event that the exposure is varied, a comparison with the portion exposed with the common reference patch makes it possible to exactly determine difference of exposure between the achromatic patch section and the color patch section.

To achieve the above-mentioned object, the present invention provides a film chart, in which a color negative film is exposed and developed, said film chart comprising:

a reference exposure patch exposed with an achromatic light also permitting that light quantity is zero; and

a series of achromatic exposure patches exposed with achromatic lights associated with a series of light exposures including light exposures larger 3.5 or more in a logarithmic range than a light exposure in said reference exposure patch.

In the film chart according to the present invention as mentioned above, it is preferable that said series of achromatic exposure patches are exposed with achromatic lights associated with a series of light exposures including light exposures larger 4.0 or more in a logarithmic range than a light exposure in said reference exposure patch.

The use of the film chart thus created over the wide range of exposure area makes it possible to readily obtain a great accuracy of color profile.

It is acceptable that the film chart of the present invention is simply provided with the above mentioned series of achromatic exposure patches and the reference patch only, the series of achromatic exposure patches and the color patches as well, or alternatively a set of sheets on which a series of achromatic exposure patches are provided and sheets on which color patches are provided.

It is acceptable that the film chart of the present invention is created using the film chart original plate according to the present invention, or alternatively using another means.

In the film chart according to the present invention as mentioned above, it is preferable that said film chart further comprises a color patch group on each of three primary colors in the color negative film, said color patch group including color patches having photographic densities existing from highest photographic density in a density area realizable in form of characteristic of the color negative film within 20% of a width of the density area, and color patches having photographic densities existing from lowest photographic density in the density area realizable in form of characteristic of the color negative film within 6% of the width of the density area.

The color patch group as mentioned above, as will be described, covers a so-called straight line of the characteristic curve of the color film. The use of the film chart having such a color patch group makes it possible to readily obtain a great accuracy of color profile.

### BRIEF DESCRIPTION OF THE DRAWINGS

FIG. 1 is a perspective view of a digital printer in which a film chart according to an embodiment of the present invention is used to create a color profile.

FIG. 2 is a typical illustration showing a structure of a scanner section of an image-input machine.

FIG. 3 is a view of a film chart original plate according to an embodiment of the present invention in which a film chart according to an embodiment of the present invention is created.

FIG. 4 is a view showing a film chart according to an embodiment of the present invention.

FIG. 5 is a view showing a heating & pressing machine for creating a film chart.

FIG. 6 is a graph representative of a characteristic curve of a color negative film of light exposing the color negative film to a cyan color component.

FIG. 7 is a graph representative of a characteristic curve of a color negative film of light exposing the color negative film to a magenta color component.

FIG. 8 is a graph representative of a characteristic curve of a color negative film of light exposing the color negative film to a yellow color component.

FIG. 9 is an explanatory view useful for understanding a creating procedure of a gray patch section.

FIG. 10 is an explanatory view useful for understanding a procedure of creating a film chart original plate in its entirety.

### DETAILED DESCRIPTION OF PREFERRED EMBODIMENTS

Embodiments of the present invention will be described with reference to the accompanying drawings.

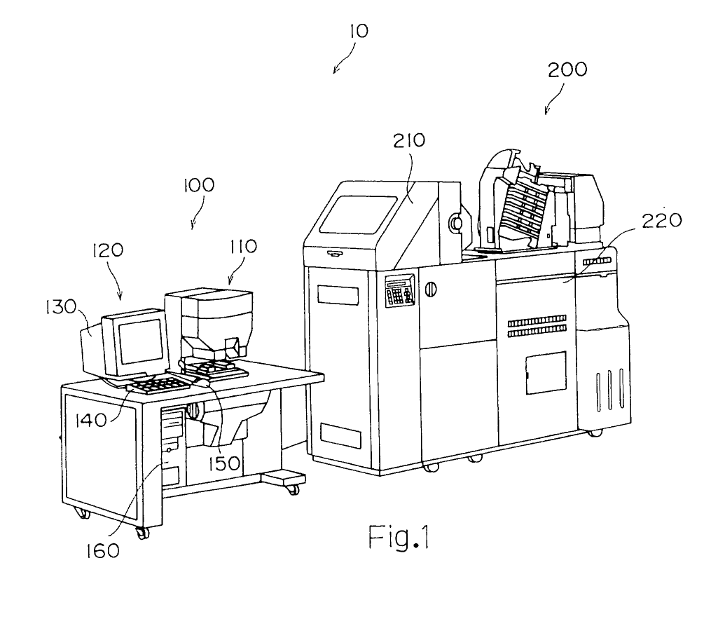

FIG. 1 is a perspective view of a digital printer in which a film chart according to an embodiment of the present invention is used to create a color profile.

A digital printer 10 comprises an image input machine 100 and an image output machine 200.

The image input machine 100 comprises a scanner section 110 for optically sequentially reading a plurality of frame images recorded on a developed photographic film (a negative film) from the photographic film, and an image examination processing section 120 for performing an examination operation for the image thus read and further performing an image processing. The image examination processing section 120 comprises a CRT display unit 130, a dedicated keyboard 140, a mouse 150 and a circuit section 160. The circuit section 160 comprises a computer circuit section constituting a computer system together with the CRT display unit 130, the dedicated keyboard 140 and the mouse 150, and an image processing substrate which is a hardware for an image processing use only. Detailed explanation of the circuit section 160 will be omitted, since it does not directly relate to the present invention.

The image output machine 200 comprises a laser printer section 210 for scanning a laser light modulated in accordance with an image obtained by the image input machine 100 to expose an image on a photographic paper, and a processor section 220 for developing the photographic paper exposed by the laser printer section 210 to obtain a print photograph. The external structure of the image output machine 200 would be omitted in explanation.

A film chart according to an embodiment of the present invention is used for the purpose of creating a color profile associated with the scanner section 110.

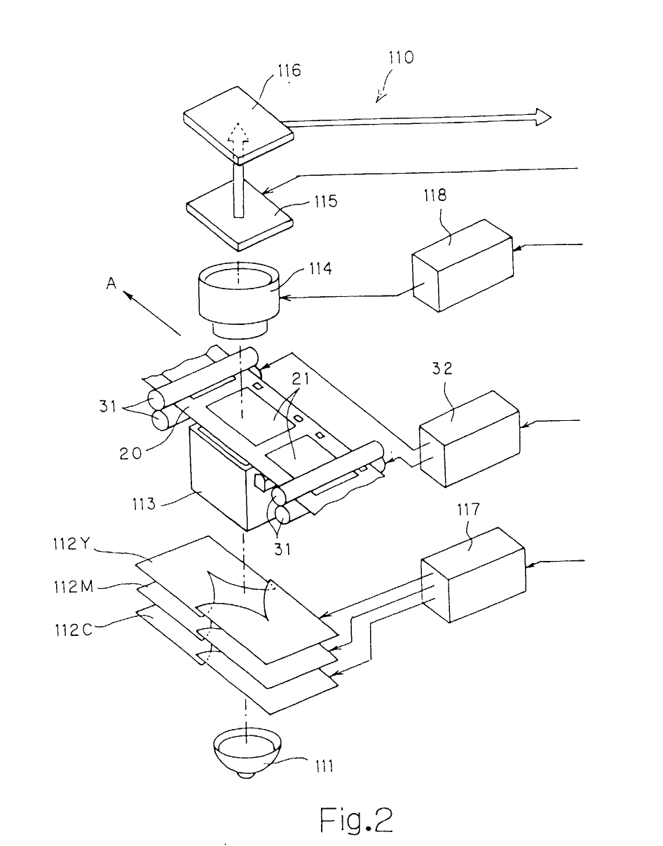

FIG. 2 is a typical illustration showing a structure of the scanner section 110 of the image input machine 100.

Here, a developed photographic film 20 is set to a film carrier (not illustrated) having a feeding roller 31 and a feed driving section 32, and the feeding roller 31 is driven by the feed driving section 32, so that the photographic film 20 is fed in a direction of an arrow A to be subjected to reading of images.

The scanner section 110 is provided with a light source 111 comprising, for example, a halogen lamp or a metal halide lamp. The light emitted from the light source 111 irradiates the photographic film 20 via filters 112C, 112M and 112Y, through which lights of C (cyan), M (magenta) and Y (yellow) passes, respectively, and further via a diffusion box 113.

Each of the filters 112C, 112M and 112Y has in its center an aperture through which light passes without being subjected to an effect of the filter. Through the periphery of the aperture of the associated filter, light subjected to the effect by the filter passes. A filter control unit 117 controls sizes of the apertures of the respective filters and thereby controlling a degree of an effect of the respective filter. The lights passing through the filters 112C, 112M and 112Y are diffused in the diffusion box 113 so as to be uniform light and irradiate the photographic film 20.

The light passing through the photographic film 20 reaches a CCD photosensor 115 via a zoom lens 114. The image recorded on the photographic film 20 is formed on a plane of the CCD photosensor 115 including a sensor surface by an effect of the zoom lens 114. An A/D converter 116 converts an image signal obtained through the CCD photosensor 115 into digital image data (for the purpose of simplification it happens that an image on data is simply referred to as an image), and transfers the converted digital image data to the circuit section 160.

The zoom lens 114 is driven by a zoom lens driving section 118 to control the focal length, so that an image of the magnification according to the focal length of the zoom lens 114 is formed on a sensor surface of the CCD photosensor 115. The CCD photosensor 115 comprises line sensors in which a large number of photoelectric elements are arranged in a direction of width of the photographic film 20. The line sensors are lined three deep in a direction of feeding of the photographic film 20. The surfaces of the line sensors are provided with color separation filters for R (red), G (green) and B (blue) to read components for R (red), G (green) and B (blue) of a frame image recorded on the photographic film 20, respectively. Image reading by the three line sensors is repeatedly performed while the photographic film 20 is fed, so that the frame image of the photographic film 20 is read on a two-dimensional basis and thereby obtaining image signals of components for R, G and B. The image signals thus obtained through the CCD photosensor 115 are, as mentioned above, converted into the digital image data by the A/D converter 116 and are transmitted to the circuit section.

The circuit section 160 shown in FIG. 1 applies a color conversion (profiling) to the image data in accordance with the color profile of the scanner section 110 and the color profile of the CRT section 130. The image data after the color conversion is transmitted to the CRT section 130 and is displayed. The image displayed on the CRT section 130 is used for examination.

When the examination is performed, information representative of an image processing condition according to a result of the examination is transmitted to an image processing substrate so that various sorts of image processing are performed. An image after the image processing is transmitted to the image output machine 200 and is used as a signal for laser light modulation at the time when an exposure by a laser light is performed.

When the scanner section 110 creates a color profile, a film chart according to an embodiment of the present invention is set to a film carrier instead of the photographic film 20 shown in FIG. 2, so that patches constituting the chart are read to obtain image data. While there are determined beforehand calorimetric values based on the transmitted lights of the original plate original plate used for creation of the film chart, the image data are associated with the calorimetric values to create the color profile.

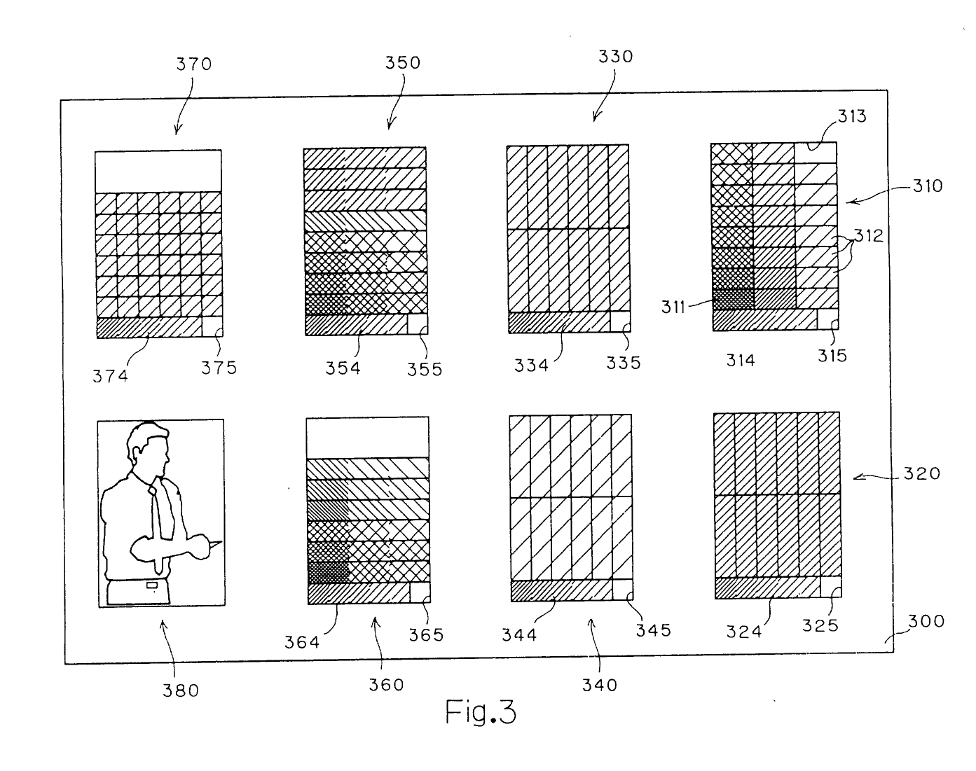

FIG. 3 is a view of a film chart original plate according to an embodiment of the present invention in which a film chart according to an embodiment of the present invention is created.

A film chart original plate 300 shown in FIG. 3 comprises a gray patch section 310 in which achromatic patches are arranged, six color patch sections 320, . . . , 370 in which color patches are arranged, and a general image section 380 having a general image such as a portraiture.

In the gray patch section 310, as the achromatic patches, there are arranged a black patch 311 having the highest optical density and 22 pieces of gray patches 312 having a series of optical density. The density of those 22 pieces of gray patches 312 is given by 0.10, 0.33, 0.57, 0.80, 1.03, 1.27, 1.50, 1.73, 1.97, 2.20, 2.43, 2.67, 2.90, 3.13, 3.37, 3.60, 3.83, 4.07, 4.30, 4.53, 4.77, 5.00. The black patch 311 is one to which a light shielding paper (a black paper) is appended and has an optical density more than 5.00. The gray patch section 310 is provided with a punch 313 that is used as a patch having an optical density less than 0.10. The punch, which is used as the patch, is referred to as a “punched patch” hereinafter.

Of the gray patch section 310, a portion on which the black patch 311 is provided corresponds to the black patch section referred to in the present invention. A portion on which 22 pieces of gray patches 312 and the punched patch 313 are provided corresponds to the achromatic patch section referred to in the present invention.

Of the six color patch sections 320, . . . , 370, the fourth color patch section 350 is provided with tone patches for CMYK four primary colors, and the fifth color patch section 360 is provided with tone patches for RGB three primary colors. The first to third color patch sections 320, 330 and 340 are provided with mixed color patches of high density, middle density and low density, respectively. And finally, the seventh color patch section 370 is provided with various sorts of skin color patches.

The gray patch section 310 and the six color patch sections 320, . . . , 370 are provided with common gray patches 314, . . . 374, and common punch patches 315, . . . 375, respectively. Those common gray patches 314, . . . 374, and the common punch patches 315, . . . 375 are examples of the reference patch referred to in the present invention.

Method of creating the film chart original plate 300 will be described later.

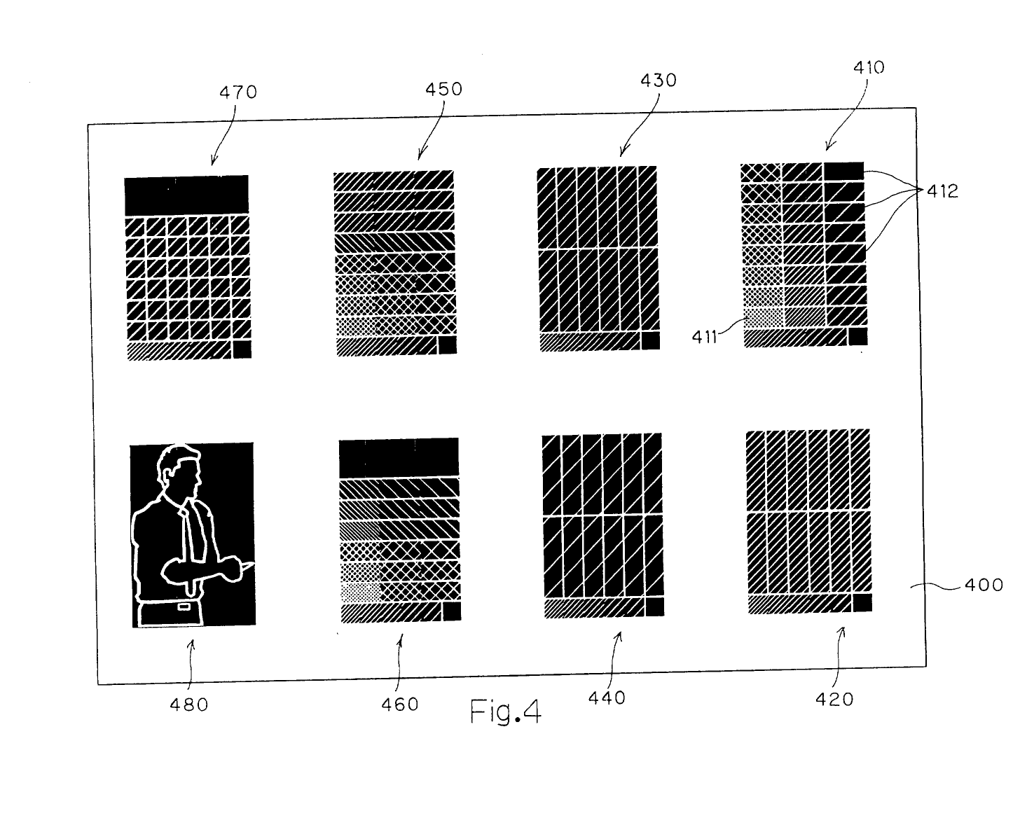

FIG. 4 is a view showing a film chart according to an embodiment of the present invention.

A film chart 400 is created by the film chart original plate 300 shown in FIG. 3, and is printed on a color negative film in accordance with a contact printing which will be described later. The film chart 400 is provided with a gray patch section 410, six color patch sections 420, . . . , 470, and a general image section 480, which are associated with the gray patch section 310, the six color patch sections 320, . . . , 370, and the general image section 380 of the film chart original plate 300 shown in FIG. 3, respectively. Of the patches provided on the gray patch section 410 of the film chart 400, a patch 411 associated with the black patch 311 of the film chart original plate 300 corresponds to the reference exposure patch referred to in the present invention, which is one exposed by achromatic light wherein a light quantity becomes substantially zero by blocking of a shielding paper. Further, of the patches provided on the gray patch section 410 of the film chart 400, patches 412 associated with the 22 pieces of gray patches 312 and the punched patch 313 correspond the achromatic exposure patches referred to in the present invention. A large number of patches provided on the six color patch sections 420, . . . , 470 of the film chart 400 constitutes the color patch group referred to in the present invention.

The film chart 400 is divided into eight sheets including the gray patch section 410, the color patch sections 420, . . . , 470, and the general image section 480. The eight sheets are set to the film carrier one by one. A set of eight divided sheets is also an embodiment of the film chart referred to in the present invention. Further, a single sheet including the gray patch section 410, of the eight divided sheets, is also an embodiment of the film chart referred to in the present invention.

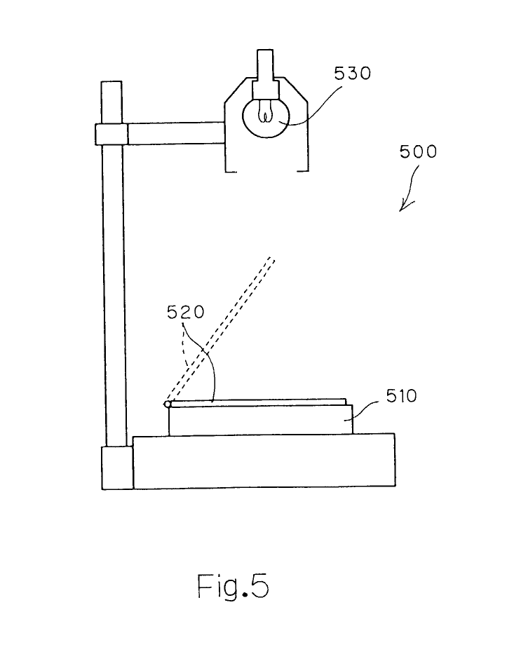

FIG. 5 is a view showing a heating & pressing machine for creating a film chart.

A heating & pressing machine 500 creates a film chart by contact printing.

An unexposed color negative film is disposed on a printing support 510 of the heating & pressing machine 500. The film chart original plate shown in FIG. 3 is mounted inside a glass cover 520, which opens and shuts selectively. The glass cover 520 shuts so that the film chart original plate contacts with the color negative film. In this condition, light of a light source 530 is projected onto the color negative film. When the exposed color negative film is developed, the film chart 400 shown in FIG. 4 is obtained.

The film chart original plate is provided with achromatic patches over a very wide range in density as mentioned above. Thus, when light of the light source 530 passes through the patches, it brings about a very large difference in light quantity. This very large difference in light quantity caused by such achromatic patches can cover with one time of printing the whole of an exposure area in which variation of an amount of exposure to the color negative film may appear in form of variation of the density.

Generally, the film chart original plate having a series of patches over 3.5 or more in density range can cover, of a characteristic curve of a color negative film, a straight line portion in which a gradient is constant and a transition portion changing over from the straight line portion to the shoulder and the led. Those portions of the characteristic curve are portions corresponding to the exposure range utilized at the time of the usual photography. When the color profile is created in accordance with the color negative film created with cover of those portions of the characteristic curve, it is possible to obtain the color profile with greater accuracy within an exposure range necessary in practice.

The film chart original plate having a series of patches over 4.0 or more in density range can cover almost whole of the characteristic curve of the color negative film from the leg to the shoulder. When the color profile is created in accordance with the color negative film created with cover of the whole area of the characteristic curve, it is possible to obtain the color profile with great accuracy capable of coping with the extreme exposure condition due to photographing errors and the like.

The film chart original plate 300 shown in FIG. 3 is provided with a series of achromatic patches 311, 312 and 313 over extremely wide range such as 5.0 or more in density range. Thus, it is possible to extremely readily cover the characteristic curve of the color negative film in its entirety.

Prior to creation of the color profile, calorimetric values of transmitted lights passing through the patches provided on the film chart original plate 300 shown in FIG. 3 are measured by a colorimeter and are recorded. Further, at the time of creation of the color profile, as mentioned above, the sheets, wherein the film chart 400 shown in FIG. 4 is divided, are set to the film carrier to read the patches, so that RGB data, in which colors of the patches are represented by the RGB three primary colors, is obtained. Thus, the color profile is readily created with great accuracy in accordance with data values of the RGB data and the colorimetric values obtained by the calorimeter.

The density range of the color patches provided on the film chart original plate 300 shown in FIG. 3 is greatly narrower as compared with the density range of a series of achromatic patches 311, 312 and 313. However, there are obtained calorimetric values and data over wide range in a gray axis direction in a color space. Thus, the use of the calorimetric values and data, and the colorimetric values and data based on the color patches makes it possible to perform a conjecture also on a color area in which colorimetric values and data cannot be obtained with sufficient accuracy, and thereby obtaining the color profile with great accuracy.

When the contact printing is performed, the portions associated with the six color patch sections 320, . . . , 370 and the general image section shown in FIG. 3 are covered by an ND filter (Normal Density filter) so that an exposure amount is controlled to satisfy an exposure condition as will be explained later. The calorimetric values obtained through measurement of the transmitted light in the color patch sections in the original plate by the calorimeter are corrected in accordance with the corresponding control of the exposure amount.

The corresponding control of the exposure amount can be computed in accordance with an attenuation factor of the ND filter. However, in order to obtain the more exact value, here, density of the patches associated with the common gray patches 314, . . . 374, and the common punch patches 315, . . . 375 is measured. The corresponding control of the exposure amount can be computed in accordance with the density thus computed and the exposure characteristic of the color negative film.

Hereinafter, there will be explained exposure conditions for controlling an amount of exposure.

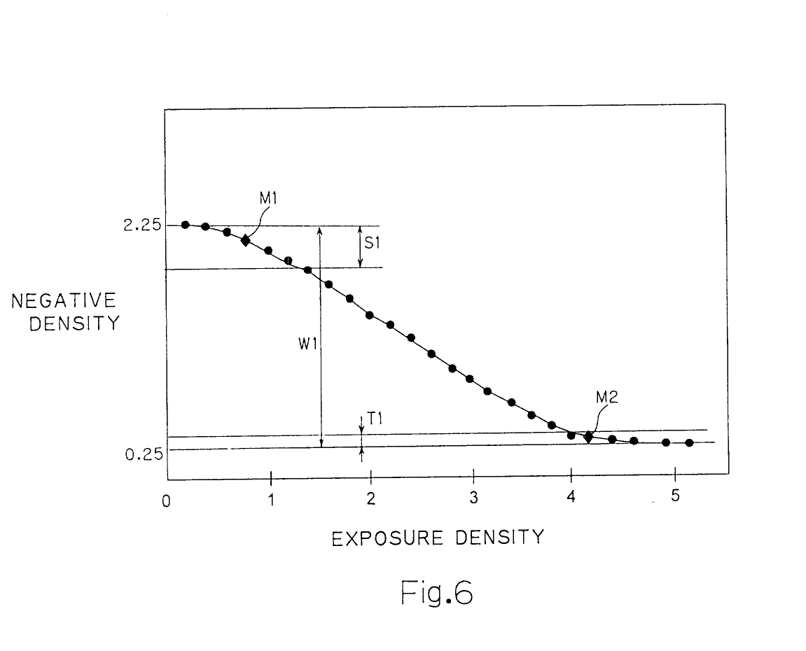

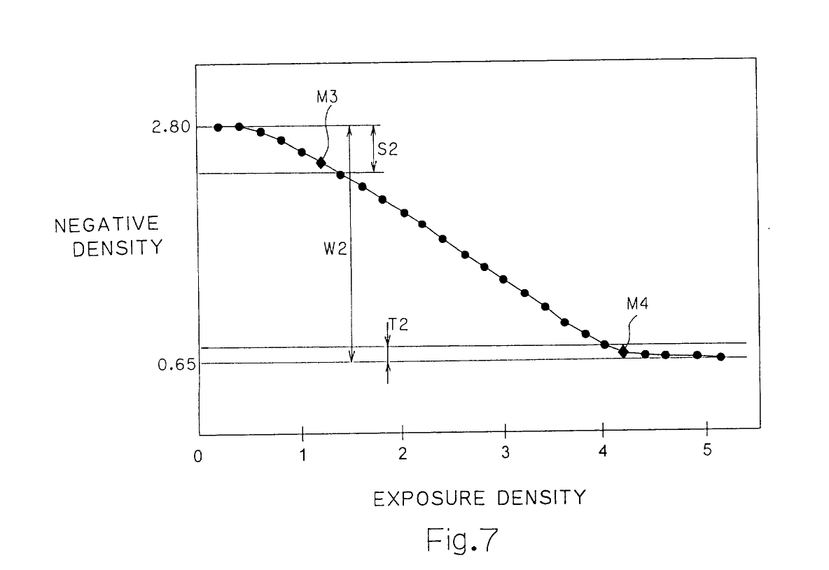

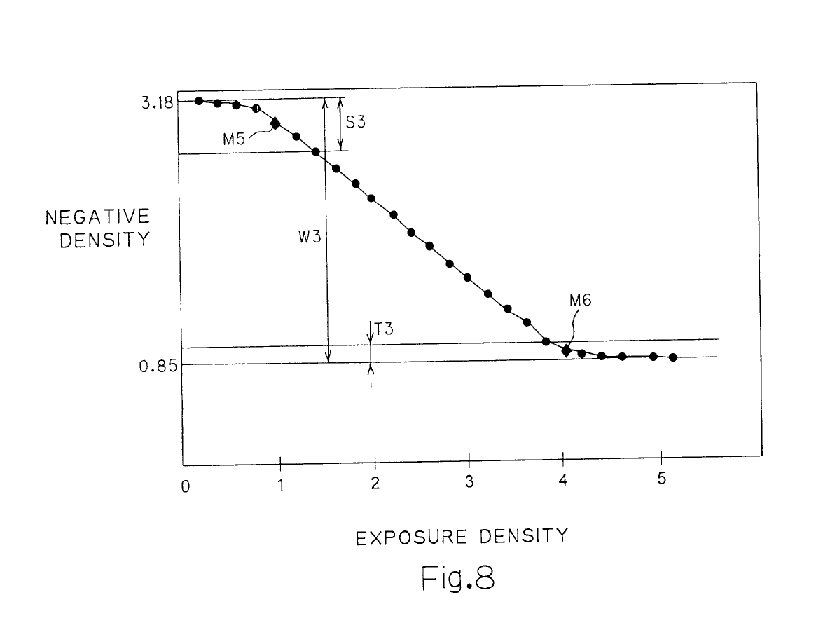

FIG. 6 is a graph representative of a characteristic curve of a color negative film of light exposing the color negative film to a cyan color component. FIG. 7 is a graph representative of a characteristic curve of a color negative film of light exposing the color negative film to a magenta color component. FIG. 8 is a graph representative of a characteristic curve of a color negative film of light exposing the color negative film to a yellow color component.

A horizontal axis of those graphs represents an exposure density of light for exposing a color negative film. A vertical axis of those graphs represents a photographic density (a negative density) occurring on an exposed color negative film. The exposure density is determined in accordance with a formula log₁₀ (1/T) where T denotes a light quantity of exposing light, and physically corresponds to density of a filter for controlling light exposure. Here, while the exposure density corresponds to the density of the patches of the film chart original plate, the exposure density is different from the density of the patches per se, and may be the density of an ideal original plate which is calculated back from the light exposure.

A density area of the photographic density (a negative density), which can be realized in form of the characteristic of the color negative film, is varied for each primary color. The density area for cyan to light is 0.25 to 2.25. The density area for magenta to light is 0.65 to 2.80. The density area for yellow to light is 0.85 to 3.18.

Each of the characteristic curves has a shoulder on the upper portion, a leg on the lower portion, and a straight-line portion in which a gradient is constant. Generally, areas S1, S2 and S3 from the highest areas in the density areas in the primary colors within 20% of width W1, W2 and W3 of the density areas in the primary colors correspond to the shoulder. And, areas T1, T2 and T3 from the lowest areas in the density areas in the primary colors within 6% of width W1, W2 and W3 of the density areas in the primary colors correspond to the leg.

A series of patches 411 and 412, which are provided on the gray patch section 410 of the film chart 400 shown in FIG. 4, are exposed with light over the extremely wide exposure areas as mentioned above, and cover the density areas of the respective primary colors in their entirety.

To create a color profile capable of coping with the density areas of the respective primary colors in their entirety with great accuracy, it is desired that density of a large number of color patches provided on the film chart is distributed to cover the straight line section in its entirety in the respective characteristic curves. For this reason, according to the present embodiment, as mentioned above, the ND filter is used to control the light exposure so that the density of the color patches covers the straight line section in its entirety. As a result, the density of the color patches is distributed in the range represented by diamond-shaped marks M1, . . . , M6, which are shown in FIGS. 6, 7 and 8 two each.

The marks M1, M3 and M5 representative of the upper limit of the density distribution of the color patches exist inside the areas S1, S2 and S3 corresponding to the shoulder of the characteristic curve on any primary colors. The marks M2, M4 and M6 representative of the lower limit of the density distribution of the color patches exist inside the areas T1, T2 and T3 corresponding to the leg of the characteristic curve on any primary colors. Accordingly, the color patch group consisting of a number of color patches provided on the film chart 400 shown in FIG. 4 covers the straight line section in its entirety in the respective characteristic curves, and thus the use of the film chart 400 makes it possible to create the color profile with greater accuracy.

Hereinafter, there will be explained the procedure of creating the film chart original plate 300 shown in FIG. 3.

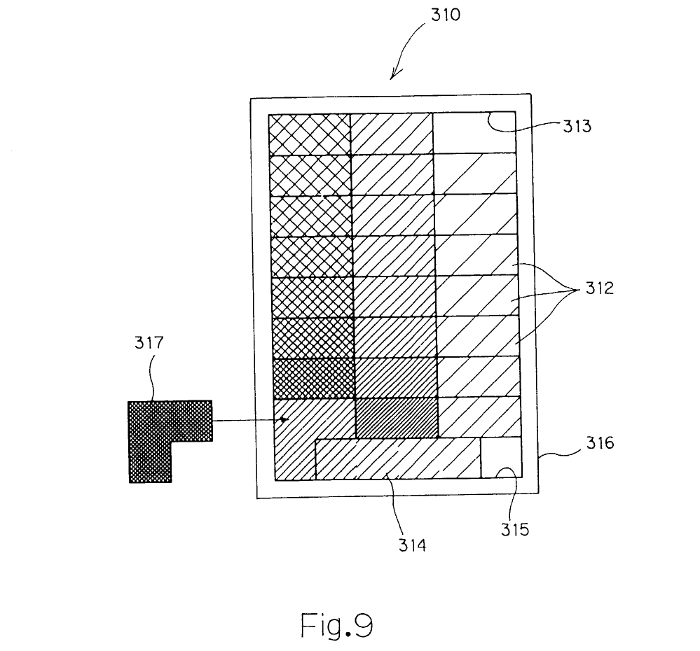

FIG. 9 is an explanatory view useful for understanding a creating procedure of a gray patch section.

FIG. 9 shows the gray patch section 310 shown in FIG. 3 with enlargement.

The gray patch section 310 is created in such a manner that a special monochrome film 316 for photogravure is exposed.

First, 22 pieces of gray patches 312 and the common gray patch 314 are created by an analog exposure on a five-step basis.

Next, a shielding paper 317 is appended to a portion of a black patch, and punched patches 313 and 315 are formed.

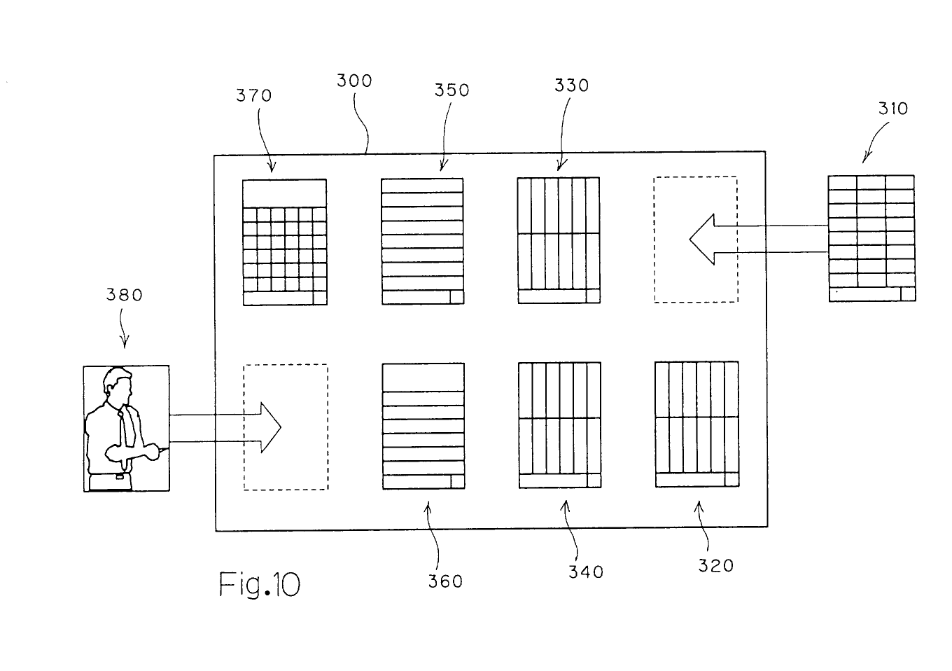

FIG. 10 is an explanatory view useful for understanding a procedure of creating a film chart original plate in its entirety.

FIG. 10 shows the film chart original plate 300 shown in FIG. 3 in a simplified form. The six color patch sections 320, . . . , 370 are printed on a reversal film in accordance with the conventional technique. The gray patch 310 is appended onto a predetermined position of the reversal film.

A general image section 380 is one in which a general image is photographed on a positive film. The general image section 380 is also appended onto a predetermined position of the reversal film.

Thus, the film chart original plate 300 is created, the film chart 400 shown in FIG. 4 is created by the film chart original plate 300, and the film chart 400 is used to readily create a color profile for a negative scanner with great accuracy.

According to the present embodiment as mentioned above, a light shielding paper (a black paper) is used by way of example of the light shielding material referred to in the present invention. It is noted, however, that the light shielding material referred to in the present invention is not restricted to paper, and it is acceptable that the light shielding material is another shielding material such as metal.

Further, according to the present embodiment as mentioned above, the gray patch section of the film chart original plate is created by means of exposure and development of the monochrome film. It is acceptable that the achromatic patch section referred to in the present invention is created by means of for example evaporation of metal. Alternatively, it is acceptable that the achromatic patch section referred to in the present invention is created in such a manner that a plurality of stages of film is stacked.

As mentioned above, according to the film chart of the present invention, it is possible to readily create a color profile for a negative scanner with great accuracy.

Further, according to the film chart original plate of the present invention, it is possible to create such a film chart.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A film chart original plate for creating a film chart, in which a plurality of patches is arranged, by a contact printing onto a color negative film, said film chart original plate comprising:
a black patch section having a predetermined black patch; and
an achromatic patch section in which a series of achromatic patches associated with a series of optical densities including optical densities smaller 3.5 or more than optical density of said black patch are arranged.

2. A film chart original plate according to claim 1, wherein said achromatic patch section is one in which a series of achromatic patches associated with a series of optical densities including optical densities smaller 4.0 or more than optical density of said black patch are arranged.

3. A film chart original plate according to claim 1, wherein said achromatic patch section is one in which of the series of achromatic patches, a lowest density of patch is a punched patch.

4. A film chart original plate according to claim 1, wherein said black patch section is one in which as the black patch, a patch made of an optical shield material is provided.

5. A film chart original plate according to claim 1, wherein said achromatic patch section is one in which a monochrome film is exposed and developed.

6. A film chart original plate according to claim 1, wherein said achromatic patch section is one in which a monochrome film for photogravure is exposed and developed.

7. A film chart original plate according to claim 1, further comprising a color patch section in which a plurality of color patches each having a predetermined color, and a predetermined reference patch are arranged, wherein said achromatic patch section is one in which a reference patch having a same spectral transmission factor as the reference patch of said color patch section is arranged.

8. A film chart, in which a color negative film is exposed and developed, said film chart comprising:
a reference exposure patch exposed with an achromatic light also permitting that light quantity is zero; and
a series of achromatic exposure patches exposed with achromatic lights associated with a series of light exposures including light exposures larger 3.5 or more in a logarithmic range than a light exposure in said reference exposure patch.

9. A film chart according to claim 8, wherein said series of achromatic exposure patches are exposed with achromatic lights associated with a series of light exposures including light exposures larger 4.0 or more in a logarithmic range than a light exposure in said reference exposure patch.

10. A film chart according to claim 8, wherein said film chart further comprises a color patch group on each of three primary colors in the color negative film, said color patch group including color patches having photographic densities existing from highest photographic density in a density area realizable in form of characteristic of the color negative film within 20% of a width of the density area, and color patches having photographic densities existing from lowest photographic density in the density area realizable in form of characteristic of the color negative film within 6% of the width of the density area.
